(19) United States
(12) Patent Application Publication
(10) Pub. No.: US 2024/0054901 A1
(43) Pub. Date: Feb. 15, 2024

(54) CONTROL APPARATUS, CONTROL SYSTEM, CONTROL METHOD, AND STORAGE MEDIUM

(71) Applicant: CANON KABUSHIKI KAISHA, Tokyo (JP)

(72) Inventor: Yoshiyuki AKIMOTO, Saitama (JP)

(21) Appl. No.: 18/353,136

(22) Filed: Jul. 17, 2023

(30) Foreign Application Priority Data
Aug. 12, 2022 (JP) 2022-128608

(51) Int. Cl. G08G 1/00; B60W 60/00

(52) U.S. Cl. CPC G08G 1/22; B60W 60/0051; B60W 60/0053; B60W 2554/80

(57) ABSTRACT

A control apparatus includes a processor configured to acquire forward information ahead of a first vehicle in a first caravan, acquire road information based on location data and map data, determine, based on the forward information and the road information, whether or not electronic connection between the first caravan and a second caravan following the first caravan is possible, and transmit to a second vehicle in the second caravan first information indicating that the electronic connection is possible in a case where it is determined that the electronic connection is possible.

### BACKGROUND

### Technical Field

One of the aspects of the embodiments relates to a control apparatus, a control system, a control method, and a storage medium, each of which controls driving of a caravan of vehicles.

### Description of Related Art

Japanese Patent Laid-Open No. 2012-30666 discloses a vehicle control system for a caravan of vehicles driving in parallel on the same lane without intervening in any general vehicles.

In the vehicle control system disclosed in Japanese Patent Laid-Open No. 2012-30666, the number of vehicles that can drive in the caravan is limited from the viewpoint of a range in which a driver of a leading vehicle in the caravan can confirm safety, change lanes, merge, and the like. Thus, the contribution to driver shortage and reduction of the burden on the driver is insufficient.

### SUMMARY

A control apparatus according to one aspect of the disclosure includes a memory storing instructions, and a processor configured to execute the instructions to acquire forward information ahead of a first vehicle in a first caravan, acquire road information based on location data and map data, determine, based on the forward information and the road information, whether or not electronic connection between the first caravan and a second caravan following the first caravan is possible, and transmit to a second vehicle in the second caravan first information indicating that the electronic connection is possible in a case where it is determined that the electronic connection is possible. A control apparatus according to another aspect of the disclosure includes a memory storing instructions, and a processor configured to execute the instructions to receive from a first vehicle in a first caravan first information indicating that electronic connection between the first caravan and a second caravan following the first caravan is possible, notify, in a case where the first information is received, a driver of a second vehicle in the second caravan that electronic connection is possible, determine, based on operation of a notified driver, whether or not to automatically drive the second vehicle, and perform automatic driving, in a case where it is determined that the automatic driving is to be performed, based on information on a distance from the first caravan. A control method corresponding to each of the above control apparatuses also constitutes another aspect of the disclosure. A storage medium storing a program that causes a computer to execute the above control method also constitutes another aspect of the disclosure.

A control system according to another aspect of the disclosure is configured to control driving of a first caravan and a second caravan following the first caravan. The control system includes a first control apparatus provided to the first caravan, and a second control apparatus provided to the second caravan. The first control apparatus includes a memory storing instructions, and a processor configured to execute the instructions to acquire forward information ahead of a first vehicle in the first caravan, acquire road information based on location data and map data, determine, based on the forward information and the road information, whether or not electronic connection between the first caravan and the second caravan is possible, and transmit to the second vehicle first information indicating that the electronic connection is possible in a case where it is determined that the electronic connection is possible. The second control apparatus includes a memory storing instructions, and a processor configured to execute the instructions to receive the first information from the first vehicle, notify, in a case where the first information is received, a driver of a second vehicle in the second caravan that the electronic connection is possible, determine, based on operation of a notified driver, whether or not to automatically drive the second vehicle, and perform automatic driving, in a case where it is determined that the automatic driving is to be performed, based on information on a distance from the first caravan.

Further features of the disclosure will become apparent from the following description of embodiments with reference to the attached drawings.

### BRIEF DESCRIPTION OF THE DRAWINGS

FIG. 1 illustrates a preceding caravan according to a first embodiment.

FIG. 2 is a configuration diagram of a leading vehicle in the preceding caravan in the first embodiment.

FIG. 3 illustrates a following caravan in the first embodiment.

FIG. 4 is a configuration diagram of a leading vehicle in the following caravan in the first embodiment.

FIG. 5 is a flowchart of control by the leading vehicle in the preceding caravan in the first embodiment.

FIG. 6 is a flowchart of control by the leading vehicle in the following caravan in the first embodiment.

FIG. 7 is a configuration diagram of a leading vehicle in a preceding caravan according to a second embodiment.

FIG. 8 is a configuration diagram of a leading vehicle in a following caravan in the second embodiment.

FIG. 9 is a configuration diagram of a line-end unmanned vehicle in the following caravan in the second embodiment.

FIG. 10 explains lengths of the preceding and following caravans in the second embodiment.

FIG. 11 is a display example of information on the number of vehicles in the caravan and an overall length of the caravan after the caravans are electronically connected in the second embodiment.

FIG. 12 is a flowchart of control for changing a notification of the number of vehicles in the caravan and the overall length of the caravan in the second embodiment.

FIG. 13 is a configuration diagram of a leading vehicle in a preceding caravan in a third embodiment.

FIG. 14 is a configuration diagram of a leading vehicle in a following caravan in the third embodiment.

FIG. 15 is a configuration diagram of a line-end unmanned vehicle in the following caravan in the third embodiment.

FIG. 16 is a flowchart of control for displaying an image captured by a line-end unmanned vehicle, on the leading vehicle in the third embodiment.

FIG. 17 is a flowchart of control in a case where electronic connection is to be canceled in a fourth embodiment.

FIG. 18 is a configuration diagram of a line-end unmanned vehicle in a preceding caravan in a fifth embodiment.

FIG. 19 explains the way of detecting a trial of cutting in by a vehicle driving in an adjacent lane and located diagonally behind the unmanned vehicle in the fifth embodiment.

FIG. 20 is a flowchart of control for canceling electronic connection and permitting an interruption into the caravan in the fifth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### First Embodiment

A description will now be given of a first embodiment according to the present disclosure. This embodiment will discuss control for electronically connecting a preceding caravan (first caravan) 1000 and a following caravan (second caravan) 2000 in a case where a specific condition is satisfied. Here, the electronic connection controls a distance between vehicles and virtually connects the vehicles using the adaptive cruise control (ACC) or the ACC and the cooperative adaptive cruise control (CACC).

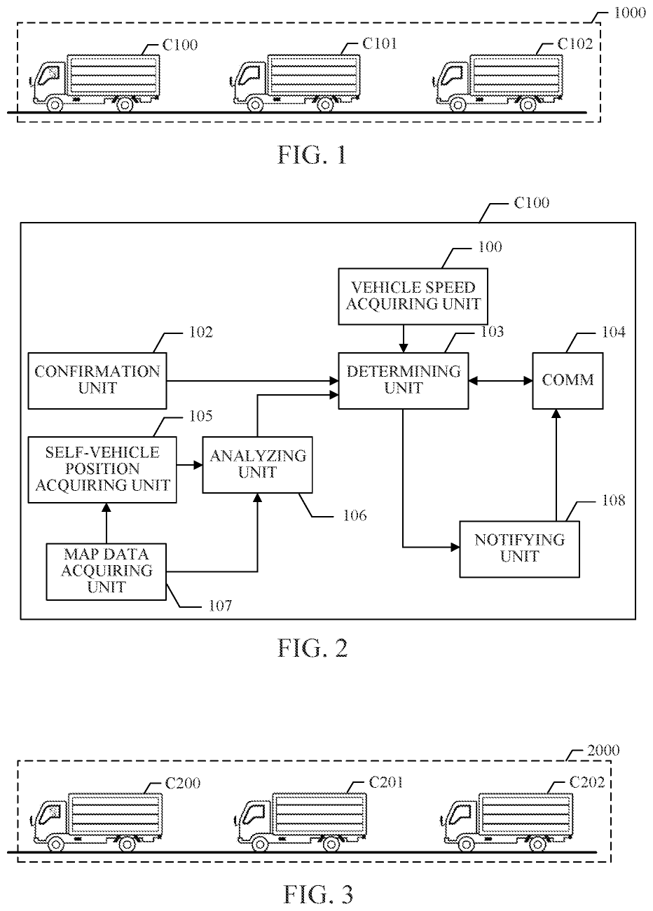

FIG. 1 illustrates the preceding caravan 1000. The preceding caravan 1000 is a caravan that includes a plurality of vehicles headed by a leading vehicle (first vehicle) C100 of the preceding caravan 1000. In this embodiment, the preceding caravan 1000 has three vehicles, a leading vehicle C100, an unmanned vehicle C101 following the leading vehicle C100, and an unmanned vehicle C102 following the unmanned vehicle C101. This embodiment is not limited to this example, and the preceding caravan 1000 may include two or four or more vehicles.

FIG. 2 is a configuration diagram of the leading vehicle C100 in the preceding caravan 1000. The leading vehicle C100 includes a vehicle speed acquiring unit (third acquiring unit) 100, a confirmation unit (first acquiring unit) 102, a determining unit (first determining unit) 103, a communication unit (first communication unit) 104, and a self-position (self-vehicle position) acquiring unit 105, an analyzing unit (second acquiring unit) 106, a map data acquiring unit 107, and a notifying unit 108. The vehicle speed acquiring unit 100 acquires the vehicle speed (speed information) of the leading vehicle C100. The confirmation unit 102 is provided to confirm the safety in front of the leading vehicle C100, and includes a device such as a forward surveillance camera, LiDAR, and millimeter-wave radar installed in the leading vehicle C100, and a processing unit configured to analyze information from the device. The confirmation unit 102 analyzes the information from the device using a technique such as machine learning and confirms whether or not there is a vehicle or falling object on the route of the leading vehicle C100, and whether or not there is rain or snow.

The self-position acquiring unit 105 identifies a driver's own vehicle position based on information (position data) such as a GPS, acceleration sensor, gyro sensor, and vehicle speed, and map data. The analyzing unit 106 analyzes information from the self-position acquiring unit 105 and the map data acquiring unit 107, and determines whether or not there is a sharp curve, whether or not there is a steep slope, whether or not there is a tunnel, whether or not a lane change is necessary, and whether or not there is an exit/merge, whether or not a difficult driving operation is necessary. That is, the analyzing unit 106 acquires road information based on the position data and the map data. Based on the information acquired from the vehicle speed acquiring unit 100, the confirmation unit 102, and the analyzing unit 106, the determining unit 103 determines whether or not electronic connection with the following caravan 2000 is possible (available).

The map data acquiring unit 107 acquires map data recorded on a storage medium in the vehicle, or map data recorded on a server or the like using mobile communication. The notifying unit 108 notifies another vehicle of the driving information such as the speed, acceleration, brake pressure, target acceleration/deceleration, and steering amount of the leading vehicle C100 via the communication unit 104. The communication unit 104 communicates the determination result of the determining unit 103, the number of vehicles in the caravan, the overall length information, the driving information and the position information notified by the notifying unit 108, or the image of the in-vehicle (on-board) cameras wirelessly between vehicles by means of radio waves, light, or the like. In a case where communication is performed between caravans such as the leading vehicles C100 and C200, the leading vehicles C100 and C200 may directly communicate or may communicate via the unmanned vehicles C101 and C102.

FIG. 3 illustrates the following caravan 2000. The following caravan 2000 is a caravan including a plurality of vehicles headed by a leading vehicle (second vehicle) C200 of the following caravan 2000. In this embodiment, the following caravan 2000 includes three vehicles: the leading vehicle C200, an unmanned vehicle C201 following the leading vehicle C200, and an unmanned vehicle C202 following the unmanned vehicle C201. This embodiment is not limited to this example, and the following caravan 2000 may include two or four or more vehicles, or may include one vehicle instead of the caravan.

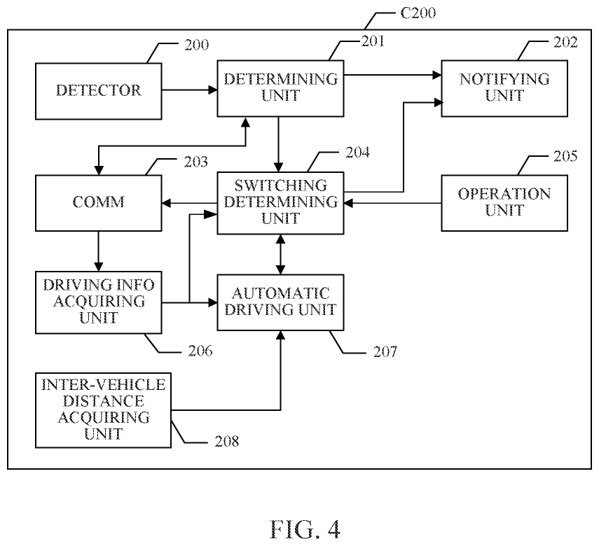

FIG. 4 is a configuration diagram of the leading vehicle C200 in the following caravan 2000. The leading vehicle C200 includes a detector (third determining unit) 200, a determining unit 201, a notifying unit 202, a communication unit (second communication unit) 203, a switching determining unit (second determining unit) 204, an operation unit 205, a driving information acquiring unit 206, an automatic driving unit 207, and an inter-vehicle distance acquiring unit 208.

The detector 200 analyzes information from a forward surveillance camera, LiDAR, millimeter-wave radar, etc., installed in the leading vehicle C200, and detects that there is no vehicle between the unmanned vehicle C102 and the leading vehicle C200 and that they are driving adjacent to each other in the front-back direction. The determining unit 201 determines whether the electronic connection is possible based on the determination results of the detector 200 and the determining unit 103 of the leading vehicle C100. The notifying unit 202 notifies the driver that the determining unit 201 has determined that the electronic connection is possible and that the switching determining unit 204 has determined that the electronic connection has been established. The notifying unit 202 may perform display notification using a display apparatus or the like, voice notification, or both.

The communication unit 203 communicates the determination result determined by the determining unit 103 or information indicating that the driver of the leading vehicle C200 desires electronic connection. The communication unit 203 exchanges information such as driving information, position information, and in-vehicle camera image of the notifying unit 108 of the leading vehicle C100 in the preceding caravan 1000. Communication between vehicles is performed wirelessly by means of radio waves, light, or the like.

In a case where the determining unit 201 determines that the electronic connection is possible and information has been obtained through the operation unit 205 that the driver of the leading vehicle C200 desires electronic connection, the switching determining unit 204 requires the leading vehicle C100 in the preceding caravan 1000 for driving information. The request for the driving information is made to the leading vehicle C100 via the communication unit 203. Then, in a case where the driving information is transmitted from the leading vehicle C100 in the preceding caravan 1000 via the communication unit 203, the switching determining unit 204 notifies the automatic driving unit 207 of the transmission.

The operation unit 205 detects whether the driver desires electronic connection. The detector detects by specific button operation, touch panel operation on the display unit, or voice operation. The driving information acquiring unit 206 acquires the driving information such as the speed, acceleration, brake pressure, target acceleration/deceleration, and steering amount of the leading vehicle C100 in the preceding caravan 1000 via the communication unit 203. The inter-vehicle distance acquiring unit 208 analyzes information from the forward surveillance camera, LiDAR, millimeter wave radar, etc., installed in the leading vehicle C200, and acquires a distance from the line-end unmanned vehicle C102 in the preceding caravan 1000. The automatic driving unit 207 automatically performs a driving operation to keep a certain distance from the unmanned vehicle C102 in the preceding caravan 1000 based on the information from the driving information acquiring unit 206 and the inter-vehicle distance acquiring unit 208.

As described above, in this embodiment, the control system has a first control apparatus provided in the preceding caravan 1000 and a second control apparatus provided in the following caravan 2000, and controls driving of the preceding caravan 1000 and following caravan 2000.

A description will now be given of the control in electronically connecting the preceding caravan 1000 and the following caravan 2000 according to this embodiment. A description will now be given of the control in the leading vehicle C100 in the preceding caravan 1000 in a case where the preceding caravan 1000 and the following caravan 2000 are electronically connected.

The leading vehicle C100 in the preceding caravan 1000 notifies the determining unit 103 that the forward safety has been confirmed by the confirmation unit 102 that there are no vehicles or fallen objects on the route and that there is no rain or snow. A condition J001 is that the confirmation unit 102 has confirmed the forward safety. The analyzing unit 106 analyzes information from the self-position acquiring unit 105 and the map data acquiring unit 107, and notifies the determining unit 103 that there are no sharp curves, steep slopes, tunnels, no lane changes, and no exits or merges, and thus that no difficult driving operations are required. A condition J002 is that the analyzing unit 106 has determined that a difficult driving operation is not required.

The vehicle speed acquiring unit 100 acquires the vehicle speed of the leading vehicle C100 and notifies the determining unit 103 that the preceding caravan 1000 (leading vehicle C100) is driving at a speed equal to or higher than a predetermined speed. Here, the speed equal to or higher than the predetermined level is assumed to be 50 km/h or higher, which is the minimum legal speed limit for expressways, but this embodiment is not limited to this example. A condition J003 is that the vehicle speed acquiring unit 100 detects that the leading vehicle C100 is driving at a speed equal to or higher than the predetermined speed.

Based on the information notified from the vehicle speed acquiring unit 100, the confirmation unit 102, and the analyzing unit 106, the determining unit 103 determines that electronic connection to the following caravan 2000 is possible in a case where all the conditions J001, J002, and J003 are satisfied. Then, the determination result that the electronic connection is possible is notified to the leading vehicle C200 in the following caravan 2000 via the communication unit 104. In a case where all of the conditions J001, J002, and J003 are not satisfied, the leading vehicle C200 in the following caravan 2000 is notified via the communication unit 104 that electronic connection is impossible. Alternatively, control may be performed so as not to notify that electronic connection is possible. Thereafter, in a case where the leading vehicle C200 in the following caravan 2000 requests the driving information via the communication unit 104, the determining unit 103 causes the notifying unit 108 to notify the driving information to the leading vehicle C200 in the following caravan 2000 via the communication unit 104. In a case where the leading vehicle C200 in the following caravan 2000 does not request driving information via the communication unit 104, the current driving state is continued. The determining unit 103 also monitors the information notified from the vehicle speed acquiring unit 100, the confirmation unit 102, and the analyzing unit 106 while waiting for the request for driving information.

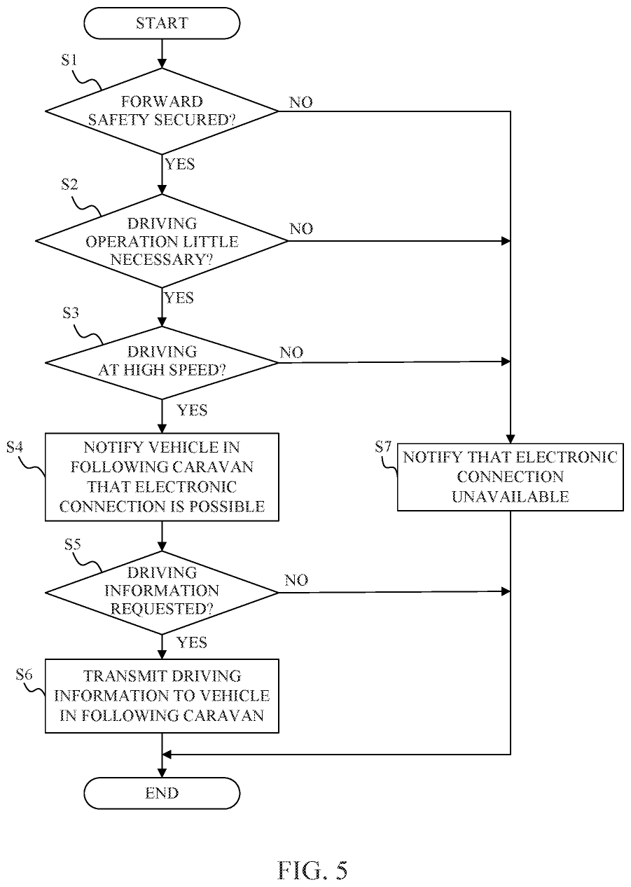

FIG. 5 is a flowchart of the control in the leading vehicle C100 in the preceding caravan 1000 in electronically connecting the preceding caravan 1000 and the following caravan 2000.

First, in step S1, the determining unit 103 determines whether or not the forward safety has been confirmed based on the information from the confirmation unit 102, such as whether there are vehicles or fallen objects on the route, and whether there is rain or snow. In a case where the determining unit 103 determines that the forward safety has been confirmed, the flow proceeds to step S2. On the other hand, in a case where the determining unit 103 determines that the forward safety has not been confirmed, the flow proceeds to step S7.

In step S2, the determining unit 103 determines whether a difficult driving operation is necessary based on information from the analyzing unit 106 as to whether there is a sharp curve, a steep slope, a tunnel, a necessary lane change, and an exit or merge. In a case where the determining unit 103 determines that difficult driving operations are not required on the next driving route, the flow proceeds to step S3. On the other hand, in a case where the determining unit 103 determines that a difficult driving operation is required on the next driving route, the flow proceeds to step S7.

In step S3, the determining unit 103 determines whether or not the vehicle is driving at a constant speed or higher based on the vehicle speed information from the vehicle speed acquiring unit 100. In a case where the determining unit 103 determines that the vehicle is driving at the constant speed or higher, the flow proceeds to step S4. On the other hand, in a case where the determining unit 103 that the vehicle is not driving at a speed equal to or higher than the constant speed, the flow proceeds to step S7.

In step S4, the determining unit 103 notifies the leading vehicle C200 in the following caravan 2000 via the communication unit 104 that electronic connection is possible. Next, in step S5, the determining unit 103 determines whether or not there is a request for driving information from the leading vehicle C200 in the following caravan 2000. In a case where there is a request for driving information from the leading vehicle C200 in the following caravan 2000, the flow proceeds to step S6. On the other hand, in a case where there is no request for driving information, waiting for the request is canceled and this flow ends.

In a case where the driving information is requested from the leading vehicle C200 in the following caravan 2000 in step S5, the determining unit 103 transmits the driving information in the leading vehicle C200 via the communication unit 104 in step S6. In step S7, the determining unit 103 notifies the leading vehicle C200 in the following caravan 2000 via the communication unit 104 that the electronic connection is impossible according to the determination result in steps S1 to S3. In this embodiment, the order of steps S1 to S3 is not limited, and the order of steps S1 to S3 can be changed.

A description will now be given of control in the leading vehicle C200 in the following caravan 2000 in electronically connecting the preceding caravan 1000 and the following caravan 2000. The leading vehicle C200 in the following caravan 2000 detects that there is no vehicle between the line-end unmanned vehicle C102 in the preceding caravan 1000 and the leading vehicle C200 in the following caravan 2000, and that they are driving adjacent to each other in the front-back direction, and notifies the determining unit 201 of the detection result. A condition J004 is that the detector 200 detects that the unmanned vehicle C102 and the leading vehicle C200 are adjacent to each other.

A condition J005 is that information that the determining unit 103 in the leading vehicle C100 in the preceding caravan 1000 has determined that electronic connection is possible is received via the communication unit 203. In a case where the determining unit 201 determines that all the conditions J004 and J005 are satisfied, it notifies the notifying unit 202 and the switching determining unit 204 that electronic connection is possible. A condition J006 is that the determining unit 201 has determined that electronic connection is possible.

The notifying unit 202 notifies the driver that the determining unit 201 has determined that electronic connection is possible. The operation unit 205 detects whether the driver desires the electronic connection. A condition J007 is that the operation unit 205 detects that the driver desires electronic connection. In a case where the switching determining unit 204 determines that all the conditions J006 and J007 are satisfied, the switching determining unit 204 issues a request for driving information to the leading vehicle C100 in the preceding caravan 1000 via the communication unit 203. In a case where driving information is transmitted from the leading vehicle C100 in the preceding caravan 1000 via the communication unit 203, the switching determining unit 204 notifies the automatic driving unit 207 of it. The switching determining unit 204 notifies the driver via the notifying unit 202 of switching to electronic connection.

The automatic driving unit 20π electronically connects with the line-end unmanned vehicle C102 in the preceding caravan 1000, based on the information from the driving information acquiring unit 206 and the inter-vehicle distance acquiring unit 208. The automatic driving unit 207 notifies the switching determining unit 204 of switching to electronic connection. The switching determining unit 204 notifies the driver via the notifying unit 202 of switching to electronic connection.

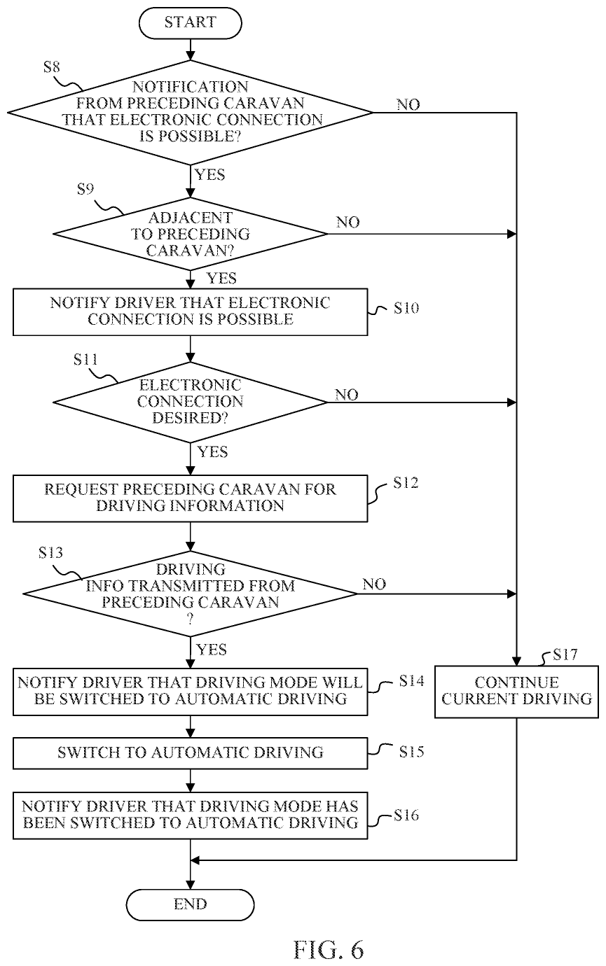

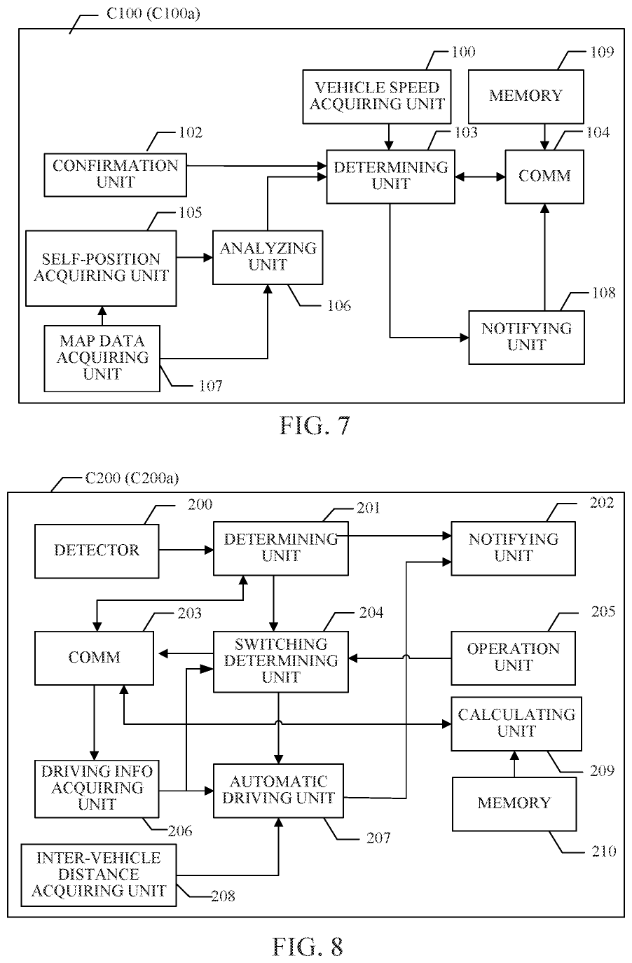

FIG. 6 is a flowchart of control in the leading vehicle C200 in the following caravan 2000 in electronically connecting the preceding caravan 1000 and the following caravan 2000.

First, in step S8, the determining unit 201 determines whether or not it has received, via the communication unit 203, a notification that the determining unit 103 in the leading vehicle C100 in the preceding caravan 1000 has determined that electronic connection is possible. In a case where the determining unit 201 has not received this notification, the flow proceeds to step S17 to continue the current driving. On the other hand, in a case where the determining unit 201 has received this notification, the flow proceeds to step S9.

In step S9, the determining unit 201 determines based on the detection information from the detector 200 whether or not the preceding caravan 1000 and the following caravan 2000 are driving adjacent to each other in the front-back direction. In a case where the determining unit 201 determines that the preceding caravan 1000 and the following caravan 2000 are not driving adjacent to each other in the front-back direction, the flow proceeds to step S17 to continue the current driving. On the other hand, in a case where the determining unit 201 determines that the preceding caravan 1000 and the following caravan 2000 are driving adjacent to each other in the front-back direction, the flow proceeds to step S10.

In step S10, the determining unit 201 notifies the driver of the leading vehicle C200 and the switching determining unit 204 via the notifying unit 202 that electronic connection is possible. Next, in step S11, the switching determining unit 204 determines whether or not the driver of the leading vehicle C200 desires electronic connection based on the operation of the operation unit 205. In a case where the switching determining unit 204 determines that the driver of the leading vehicle C200 does not desire the electronic connection, the flow proceeds to step S17 to continue the current driving. On the other hand, in a case where the switching determining unit 204 determines that the driver of the leading vehicle C200 desires electronic connection, the flow proceeds to step S12.

In step S12, the switching determining unit 204 requests the leading vehicle C100 for driving information via the communication unit 203. Next, in step S13, the switching determining unit 204 determines whether or not driving information has been transmitted from the leading vehicle C100 via the communication unit 203. In a case where the switching determining unit 204 determines that the driving information has not yet been transmitted from the leading vehicle C100, the flow proceeds to step S17 to continue the current driving. On the other hand, in a case where the switching determining unit 204 determines that the driving information has been transmitted from the leading vehicle C100, the flow proceeds to step S14.

In step S14, the switching determining unit 204 notifies the automatic driving unit 207 and notifies the driver via the notifying unit 202 that the driving mode will be switched to the automatic driving mode. Next, in step S15, the automatic driving unit 207 switches to the automatic driving based on the information from the driving information acquiring unit 206 and the inter-vehicle distance acquiring unit 208, and electronically connects to the line-end unmanned vehicle C102 in the preceding caravan 1000. Next, in step S16, the automatic driving unit 207 notifies the switching determining unit 204 that the driving mode has been switched to the automatic driving mode. In response, the switching determining unit 204 notifies the driver that the driving mode has been switched to the automatic driving mode via the notifying unit 202 and ends this flow.

This embodiment has discussed the control in electronically connecting the preceding caravan 1000 and the following caravan 2000. This control can shorten a distance between the unmanned vehicle C102 in the preceding caravan 1000 and the leading vehicle C200 in the following caravan 2000, and thereby can improve fuel efficiency by reducing air resistance. Switching the leading vehicle C200 to automatic driving can reduce the fatigue of the driver of the leading vehicle C200.

This embodiment relates to control for determining whether or not the determining unit 201 has received a determination (notification) that electronic connection is possible, but this embodiment is not limited to this example. For example, the determining unit 201 may inquire of the determining unit 103 whether this is an electronically connectable state, and the response may be used as a condition for switching to the electronic connection.

### Second Embodiment

A description will now be given of a second embodiment according to the present disclosure. In caravan driving, the overall length of the caravan becomes long, and caution is required in overtaking. Thus, the driver of the vehicle driving behind the caravan may be notified of the overall length of the caravan and be cautioned. The first embodiment has discussed the control in electronically connecting the caravans, but electronically connecting the caravans changes the overall length of the entire caravan. Therefore, the driver of the vehicle driving behind the caravan may be notified of updated information on the overall length of the caravan. This embodiment will discuss control for changing notification of the number of vehicles and the overall length of the caravan to the driver behind the caravan, after the caravans are electronically connected.

FIG. 7 is a configuration diagram of the leading vehicle C100 (C100a) in the preceding caravan 1000 in this embodiment. The leading vehicle C100a includes a vehicle speed acquiring unit 100, a confirmation unit 102, a determining unit 103, a communication unit 104, a self-position acquiring unit 105, an analyzing unit 106, a map data acquiring unit 107, a notifying unit 108, and a memory 109. The memory 109 stores the number of vehicles in the caravan, overall length information, and set inter-vehicle distance information. The set inter-vehicle distance information is, for example, a distance between vehicles set in the electronic connection, but is not limited to this example. In the leading vehicle C100a of this embodiment, the configuration other than the memory 109 is the same as that of the leading vehicle C100 of the first embodiment, and thus a description thereof will be omitted.

FIG. 8 is a configuration diagram of the leading vehicle C200 (C200a) in the following caravan 2000 in this embodiment. The leading vehicle C200a includes a detector 200, a determining unit 201, a notifying unit 202, a communication unit 203, a switching determining unit 204, an operation unit 205, a driving information acquiring unit 206, an automatic driving unit 207, an inter-vehicle distance acquiring unit 208, an overall length calculating unit 209, and a memory 210. While the caravans are electronically connected, the overall length calculating unit 209 aggregates the number of vehicles in the caravan stored in the leading vehicle of each caravan, the overall length information, and the set inter-vehicle distance information, and calculates the number of vehicles in the electronically connected caravan and overall length of the electronically connected caravan. The memory 210 stores the number of vehicles in the caravan (following caravan 2000), overall length information about the caravan, and set inter-vehicle distance information in the caravan. The set inter-vehicle distance information is, for example, a distance between vehicles set in the electronic connection, but is not limited to this example. The configuration of the leading vehicle C200a according to this embodiment is the same as that of the leading vehicle C200 of the first embodiment, except for the overall length calculating unit 209 and the memory 210, and thus a description thereof will be omitted.

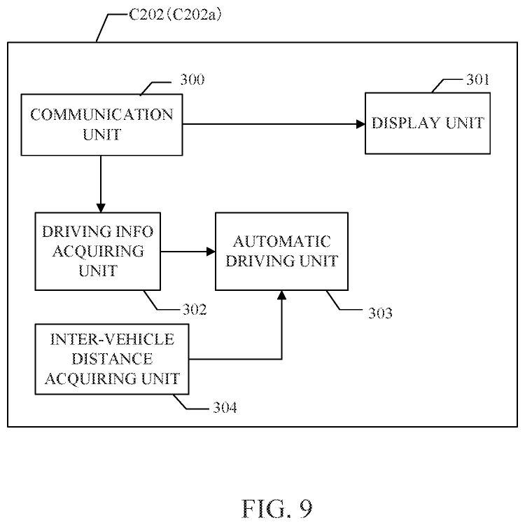

FIG. 9 is a configuration diagram of the line-end unmanned vehicle C202 (C202a) in the following caravan 2000 in this embodiment. The line-end unmanned vehicle C202a includes a communication unit 300, a display unit 301, a driving information acquiring unit 302, an automatic driving unit 303, and an inter-vehicle distance acquiring unit 304. The communication unit 300 exchanges information such as information on the number of vehicles in the caravan, overall length information, driving information, position information, and in-vehicle camera images by radio communication between vehicles using means such as radio waves and light. The display unit 301 notifies the driver of the vehicle driving behind the caravan of the number of vehicles in the caravan and the overall length information about the caravan by means of a display unit such as an electronic display apparatus which can arbitrarily change numerical values. The driving information acquiring unit 302 acquires driving information such as the speed, acceleration, brake pressure, target acceleration/deceleration, and steering amount of the leading vehicle C200 in the following caravan 2000 via the communication unit 300, and notifies the automatic driving unit 303 of it. The inter-vehicle distance acquiring unit 304 analyzes information from a forward surveillance camera, LiDAR, millimeter wave radar, etc., installed in the unmanned vehicle C202a, and acquires a distance from the unmanned vehicle C201 in the following caravan 2000. The automatic driving unit 303 performs electronic connection with the unmanned vehicle C201 in the following caravan 2000 based on the information from the driving information acquiring unit 302 and the inter-vehicle distance acquiring unit 304.

A description will now be given of control for changing a notification of the number of vehicles in the caravan and the overall length of the caravan to the driver of the vehicle driving behind the caravan after the caravans are electronically connected. In a case where the preceding caravan 1000 and the following caravan 2000 are electronically connected and the switching determining unit 204 detects the switching to automatic driving, the switching determining unit 204 requests in the memory 109 of the leading vehicle C100 for the number of vehicles in the caravan, the overall length information, and set inter-vehicle distance information. Upon receiving a request for the number of vehicles in the caravan, overall length information, and set inter-vehicle distance information from the switching determining unit 204, the memory 109 transmits information to the overall length calculating unit 209 via the communication unit 104. The overall length calculating unit 209 receives from the memory 109 the number of vehicles in the preceding caravan 1000, the overall length information about the preceding caravan 1000, and the set inter-vehicle distance information about the preceding caravan 1000. The number of vehicles in the following caravan 2000 stored in the memory 210, overall length information about the following caravan 2000, and set inter-vehicle distance information about the following caravan 2000 are read out, and the number of vehicles and the overall length of the electronically connected caravan.

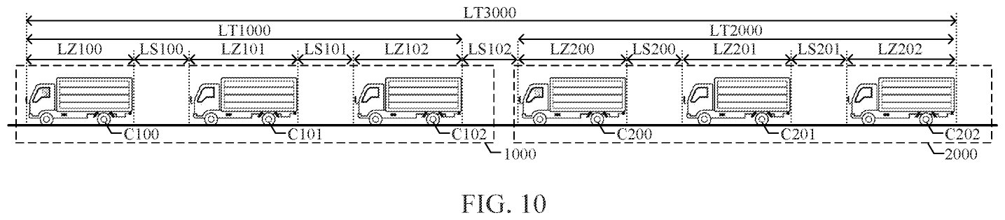

A description will now be given of an example of calculating the overall length of the electronically connected caravan. FIG. 10 explains the respective lengths of preceding caravan 1000 and following caravan 2000. Now assume that LZ100 is an overall length of the leading vehicle C100 in the preceding caravan 1000. LZ101 is an overall length of the unmanned vehicle C101. LZ102 is an overall length of the unmanned vehicle C102. LS100 is a set distance between the leading vehicle C100 and the unmanned vehicle C101. LS101 is a set distance between the unmanned vehicle C101 and the unmanned vehicle C102. LT1000 is an overall length of the preceding caravan 1000. Then, LT1000 is calculated by the following equation (1):

LT1000=LZ100+LZ101+LZ102+LS100+LS101 (1)

Similarly, assume that LZ200 is an overall length of the leading vehicle C200 in the following caravan 2000. LZ201 is an overall length of the unmanned vehicle C201. LZ202 is an overall length of the unmanned vehicle C202. LS200 is a set distance between the leading vehicle C200 and the unmanned vehicle C201. LS201 is a set distance between the unmanned vehicle C201 and the unmanned vehicle C202. LT2000 is an overall length of the following caravan 2000. Then, LT2000 is calculated by the following equation (2):

LT2000=LZ200+LZ201+LZ202+LS200+LS201 (2)

Now assume that LS102 is a set distance between the unmanned vehicle C102 in the preceding caravan 1000 and the unmanned vehicle C202 in the following caravan 2000, and LT3000 is an overall length of the electronically connected caravan. Then, LT3000 is calculated by the following equation (3):

LT3000=LT1000+LT2000+LS102 (3)

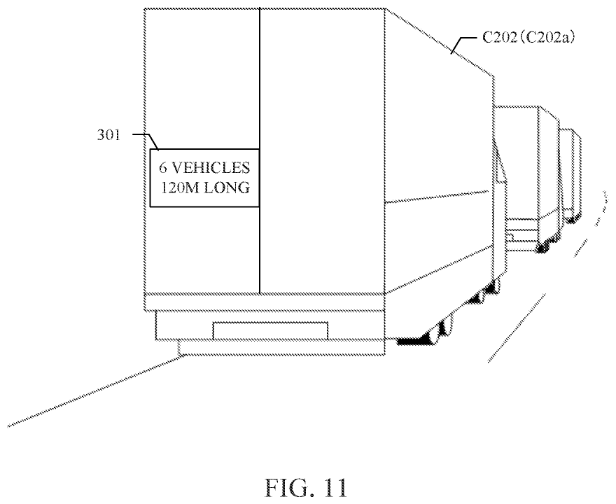

The overall length calculating unit 209 transmits information on the calculated number of vehicles and the overall length of the electronically connected caravan to the display unit 301 of the unmanned vehicle C202 via the communication unit 203. The display unit 301 displays information on the number of vehicles and overall length of the electronically connected caravan received from the overall length calculating unit 209, and notifies the driver of the vehicle driving behind the caravan. FIG. 11 is a display example of information on the number of vehicles and the overall length of the electronically connected caravan. The driver of the leading vehicle in each caravan may want to know the number of vehicles and overall length of the electronically connected caravan. Therefore, the overall length calculating unit 209 may display the information on the calculated number of vehicles and overall length of the electronically connected caravan on the display apparatus or the like of the leading vehicle of each caravan via the communication unit 203.

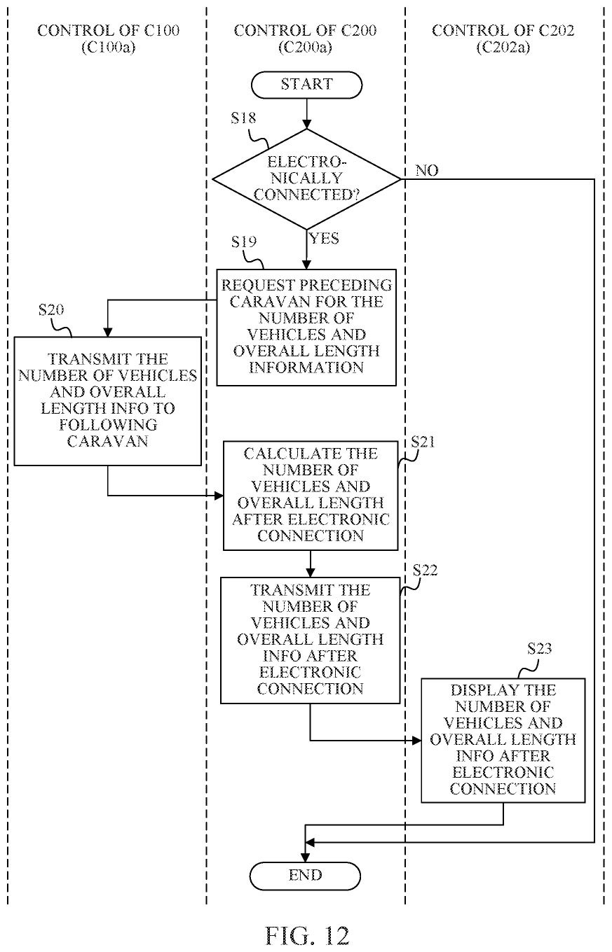

FIG. 12 is a flowchart of control for changing notification of the number of vehicles and overall length of the caravan to the driver of the vehicle driving behind the electronically connected caravan.

First, in step S18, the switching determining unit 204 of the leading vehicle C200a determines whether or not the vehicle has switched to automatic driving. In a case where the switching determining unit 204 determines that the operation has not been switched to the automatic operation, the flow ends. On the other hand, in a case where the switching determining unit 204 determines that the operation has switched to automatic operation, the flow proceeds to step S19. In step S19, the switching determining unit 204 requests the memory 109 of the leading vehicle C100a for the number of vehicles in the preceding caravan 1000, overall length information about the preceding caravan 1000, and set inter-vehicle distance information about the preceding caravan 1000.

Next, in step S20, in response to a request from the switching determining unit 204, the memory 109 transmits the number of vehicles in the preceding caravan 1000, overall length information about the preceding caravan 1000, and set inter-vehicle distance information about the preceding caravan 1000 to the overall length calculating unit 209 in the leading vehicle C200a.

Next, in step S21, the overall length calculating unit 209 receives from the memory 109 the number of vehicles in the preceding caravan 1000, the overall length information about the preceding caravan 1000, and the set inter-vehicle distance information in the preceding caravan 1000. Then, the overall length calculating unit 209 reads out the number of vehicles in the following caravan 2000, the overall length information about the following caravan 2000, and the set inter-vehicle distance information in the following caravan 2000 stored in the memory 210, and calculates the number of vehicles in the electronically connected caravan and the overall length of the electronically connected caravan. Next, in step S22, the overall length calculating unit 209 transmits information on the calculated number of vehicles and overall length of the electronically connected caravan to the display unit 301 of the unmanned vehicle C202a.

Next, in step S23, the display unit 301 displays the information on the number of vehicles and overall length of the electronically connected caravan received from the overall length calculating unit 209, and informs the driver of the vehicle driving behind the caravan.

In this embodiment, after the caravans are electronically connected, the control changes the notification of the number of vehicles and the overall length of the caravan to the driver of the vehicle driving behind the caravan. Notifying the driver of the vehicle driving behind the caravan of the number of vehicles and overall length of the electronically connected caravan can call attention to the driver trying to overtake and the driver of the vehicle driving behind the caravan can more safely overtake. In this embodiment, the overall length calculating unit is provided in the leading vehicle C200a of the following caravan 2000, but this embodiment is not limited to this exposure, and the overall length calculating unit may be provided in the leading vehicle C100a of the preceding caravan 1000.

### Third Embodiment

A description will now be given of a third embodiment according to the disclosure. In caravan driving, the driver of the leading vehicle C100 (C100b) in the preceding caravan 1000 cannot directly check the safety behind the caravan, so he needs to confirm a video (image) of the backward imaging camera mounted on the unmanned vehicle C102 and the safety behind the caravan. However, in a case where the preceding caravan 1000 and the following caravan 2000 are electronically connected, the unmanned vehicle C202 (C202b) is the last vehicle in the caravan instead of the unmanned vehicle C102. It is thus necessary to check the image from the backward imaging unit 305 installed in the unmanned vehicle C202b and the safety behind the caravan. In a case where the caravans are electronically connected, this embodiment will discuss control for displaying on the leading vehicle of the caravan an image behind the caravan captured by the last vehicle in the caravan.

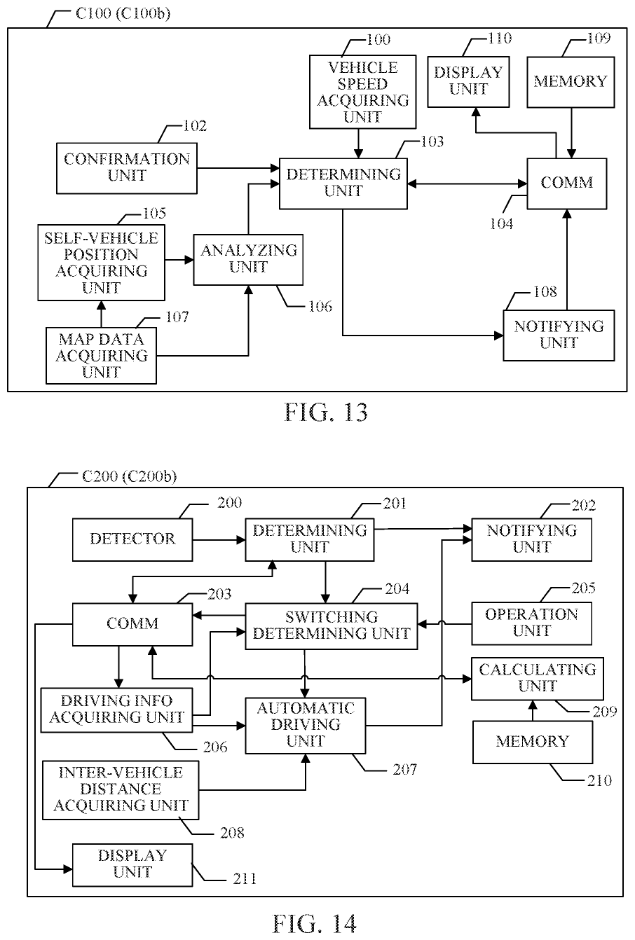

FIG. 13 is a configuration diagram of the leading vehicle C100 (C100b) in the preceding caravan 1000 in this embodiment. The leading vehicle C100b includes a vehicle speed acquiring unit 100, a confirmation unit 102, a determining unit 103, a communication unit 104, a self-position acquiring unit 105, an analyzing unit 106, a map data acquiring unit 107, a notifying unit 108, a memory 109, and a display unit. 110. The display unit 110 is a display apparatus such as a liquid crystal monitor that displays an image captured by an imaging camera installed behind the line-end vehicle in the caravan. In the leading vehicle C100b according to this embodiment, the configuration other than the display unit 110 is the same as that of the leading vehicle C100a of the second embodiment, and thus a description thereof will be omitted.

FIG. 14 is a configuration diagram of the leading vehicle C200 (C200b) in the following caravan 2000 in this embodiment. The leading vehicle C200b includes a detector 200, a determining unit 201, a notifying unit 202, a communication unit 203, a switching determining unit 204, an operation unit 205, a driving information acquiring unit 206, an automatic driving unit 207, an inter-vehicle distance acquiring unit 208, an overall length calculating unit 209, a memory 210, and a display unit 211. The display unit 211 is a display apparatus such as a liquid crystal monitor that displays an image captured by an imaging camera installed on the back of the line-end vehicle in the caravan. The display unit 211 may also serve as a function of the notifying unit 202 by notifying the driver that it has been determined that the electronic connection is possible and that the electronic connection has been made. In the leading vehicle C200b according to this embodiment, the configuration other than the display unit 211 is the same as that of the leading vehicle C200a of the second embodiment, and thus a description thereof will be omitted.

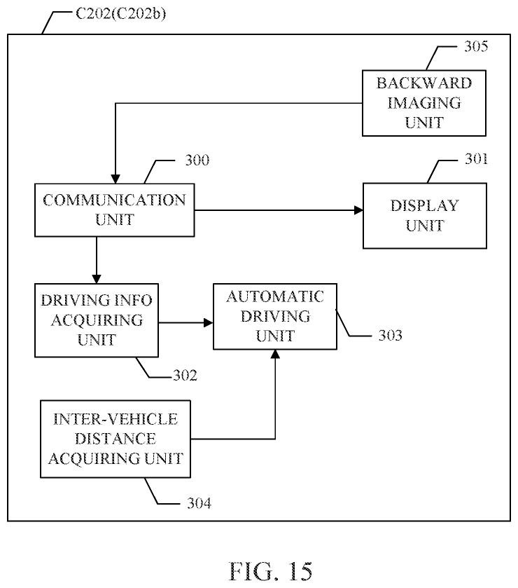

FIG. 15 is a configuration diagram of the line-end unmanned vehicle C202 (C202b) in the following caravan 2000 in this embodiment. The unmanned vehicle C202b includes a communication unit 300, a display unit 301, a driving information acquiring unit 302, an automatic driving unit 303, an inter-vehicle distance acquiring unit 304, and a backward imaging unit 305. The backward imaging unit 305 is an imaging apparatus such as a camera that captures an image behind the unmanned vehicle C202b. In the unmanned vehicle C202b according to this embodiment, the configuration other than the backward imaging unit 305 is the same as that of the unmanned vehicle C202a of the second embodiment, and thus a description thereof will be omitted.

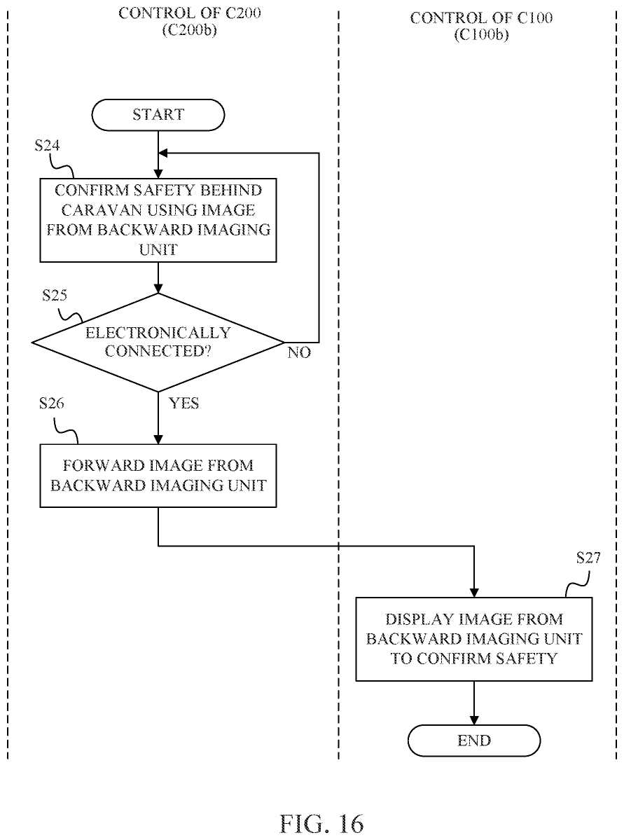

A description will now be given of control for displaying, on the leading vehicle of the caravan, a backward image captured by the line-end vehicle in the electronically connected caravan in this embodiment. FIG. 16 is a flowchart of control for displaying a backward image captured by the line-end unmanned vehicle in the caravan, on the leading vehicle in the caravan after the caravans are electronically connected in this embodiment.

First, in step S24, during normal caravan driving, the communication unit 203 in the leading vehicle C200b in the following caravan 2000 acquires a backward image from the backward imaging unit 305 in the unmanned vehicle C202b. The leading vehicle C200b displays the acquired image on the display unit 211, and the driver of the leading vehicle C200b in the following caravan 2000 confirms the safety behind the unmanned vehicle C202b.

Next, in step S25, the switching determining unit 204 determines whether or not the preceding caravan 1000 and the following caravan 2000 are electronically connected because the automatic driving unit 207 has switched to automatic driving. In a case where the switching determining unit 204 determines that the preceding caravan 1000 and the following caravan 2000 are not electronically connected, the flow returns to step S24 to continue normal caravan driving control. On the other hand, in a case where the switching determining unit 204 determines that the preceding caravan 1000 and the following caravan 2000 are electronically connected, the flow proceeds to step S26. In step S26, the switching determining unit 204 sends a command to the communication unit 203 to forward the acquired image from the backward imaging unit 305 to the communication unit 104 in the leading vehicle C100 in the preceding caravan 1000. Then, the communication unit 203 forwards the acquired image from the backward imaging unit 305 to the communication unit 104 in the leading vehicle C100b in the preceding caravan 1000.

Next, in step S27, the communication unit 104 in the leading vehicle C100b in the preceding caravan 1000 displays the forwarded image from the backward imaging unit 305 on the display unit 110. The driver of the leading vehicle C100b in the preceding caravan 1000 confirms the safety behind the electronically connected caravan from the image from the backward imaging unit 305 displayed on the display unit 110.

In this embodiment, after the caravans are electronically connected, the control displays a backward image captured by the line-end vehicle in the caravan, on the leading vehicle in the caravan. The driver of the leading vehicle after the electronic connection can check the safety behind the caravan by checking an image behind the line-end vehicle after the electronic connection. In this embodiment, the control forwards an image from the backward imaging unit 305 through the communication unit 203, but the image from the backward imaging unit 305 may be directly transmitted to the communication unit 104.

### Fourth Embodiment

A description will be given of a fourth embodiment according to the present disclosure. The first embodiment has discussed the control for electronically connecting the preceding caravan 1000 and the following caravan 2000. After they are electronically connected, any of the conditions J001, J002, or J003 in the first embodiment cannot become satisfied because the forward safety cannot be secured or a difficult driving operation becomes necessary, etc., and consequently the electronic connection is to be canceled. This embodiment will discuss control for canceling the electronic connection after the caravans are electronically connected.

In a case where any of the conditions J001, J002, and J003 in the first embodiment cannot become satisfied after the preceding caravan 1000 and the following caravan 2000 are electronically connected, the determining unit 103 determines that electronic connection cannot be continued. The determining unit 103 notifies the leading vehicle C200 in the following caravan 2000 via the communication unit 104 that it has determined that the electronic connection cannot be continued. The determining unit 201 that has received the notification via the communication unit 203 notifies the driver via the notifying unit 202 that the electronic connection will be canceled. The determining unit 201 notifies the switching determining unit 204 that the automatic operation is to be canceled.

Upon receiving the notification to cancel automatic driving, the switching determining unit 204 instructs the automatic driving unit 207 to perform control to secure an inter-vehicle distance for safely switching to manual driving. The distance between vehicles refers to the unmanned vehicle C102 in the preceding caravan 1000 and the leading vehicle C200 in the following caravan 2000, which are between the caravans, and a necessary distance between vehicles is different according to the driving speed, but in general, this embodiment assumes 100 m for 100 km/h and about 80 m for 80 km/h. In a case where the automatic driving unit 207 determines from the inter-vehicle distance information from the inter-vehicle distance acquiring unit 208 that an inter-vehicle distance enough for safe switching to manual driving has been secured, it notifies the switching determining unit 204 of switching to manual driving. The switching determining unit 204 that has received the notification of switching to manual driving from the automatic driving unit 207 notifies the driver via the notifying unit 202 of switching to manual driving. After the switching determining unit 204 notifies switching to manual driving, it instructs the automatic driving unit 207 to switch the driving mode to manual driving. The automatic driving unit 207 switches the driving mode to manual driving and transfers the driving operation to the driver.

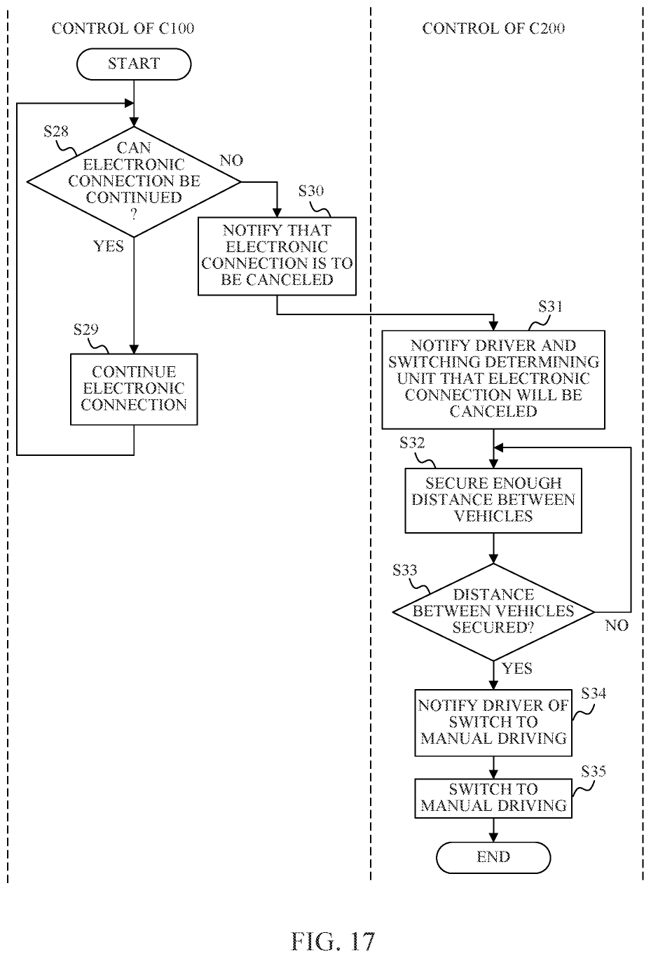

FIG. 17 is a flowchart of control in canceling the electronic connection after the caravans are electronically connected in this embodiment. First, in step S28, the determining unit 103 determines whether or not the electronic connection can be continued. In a case where the determining unit 103 determines that the electronic connection can be continued, the electronic connection is continued, and the flow returns to step S24 to continuously monitor whether the electronic connection can be continued. On the other hand, in a case where the determining unit 103 determines that the electronic connection cannot be continued, the flow proceeds to step S30. In step S30, the determining unit 103 notifies the determining unit 201 that the electronic connection is canceled.

Next, in step S31, upon receiving the notification that the electronic connection cannot be continued, the determining unit 201 notifies the driver that the electronic connection will be canceled. The determining unit 201 notifies the switching determining unit 204 that the automatic operation is to be canceled. Next, in step S32, the switching determining unit 204, which has received the notification that the automatic driving is to be canceled, instructs the automatic driving unit 207 to perform control to secure a distance between vehicles for safe switching to manual driving.

Next, in step S33, the switching determining unit 204 determines whether or not the inter-vehicle distance acquired by the inter-vehicle distance acquiring unit 208 is sufficient. In a case where the switching determining unit 204 determines that the inter-vehicle distance is not sufficient, the flow returns to step S32 so as to perform control the automatic driving unit 207 so as to secure a sufficient inter-vehicle distance. On the other hand, in a case where the switching determining unit 204 determines that a sufficient inter-vehicle distance has been secured, the flow proceeds to step S34. In step S34, the switching determining unit 204 notifies the driver that the vehicle will switch the driving mode to manual driving. Next, in step S35, the automatic driving unit 207 switches to manual driving and transfers the driving operation to the driver.

In this embodiment, the control cancels electronic connection after caravans are electronically connected. As in this embodiment, the electronic connection can be more safely canceled by switching to manual driving step by step and by notifying the driver.

This embodiment decelerates the following caravan 2000 and performs control to ensure the inter-vehicle distance using the automatic driving unit 207 in the leading vehicle C200. However, in a case where there is a vehicle just behind the unmanned vehicle C202 in the following caravan 2000 and it is difficult for the automatic driving unit 207 to secure a distance between the vehicles, the driver of the preceding caravan 1000 may be requested to keep a distance from the following caravan 2000. In a case where it is difficult to secure a distance between vehicles even in the preceding caravan 1000, the driver of the following vehicle may be decelerated after the driver of the following vehicle is notified that the vehicle will decelerate on the display unit 301 or the like. In this embodiment, the control cancels the electronic connection triggered by the determination by the determining unit 103 that the electronic connection cannot be continued. Instead of the above control, the operation unit 205 may be used to cancel the electronic connection in a case where the driver of the leading vehicle C200 no longer desires the electronic connection as a trigger. The cancelation flow follows the above flow.

### Fifth Embodiment

A description will now be given of a fifth embodiment according to the present disclosure. Caravan driving does not assume that another vehicle cuts in the caravan. However, in a case where the caravans are electronically connected, the overall length of the caravan becomes long, and cutting in the caravan may be conceivable. In a case where another vehicle that tries to cut in the caravan is detected while the electronically connected caravan is driving, this embodiment will discuss control for canceling electronic connection and for allowing another vehicle to cut in the caravan.

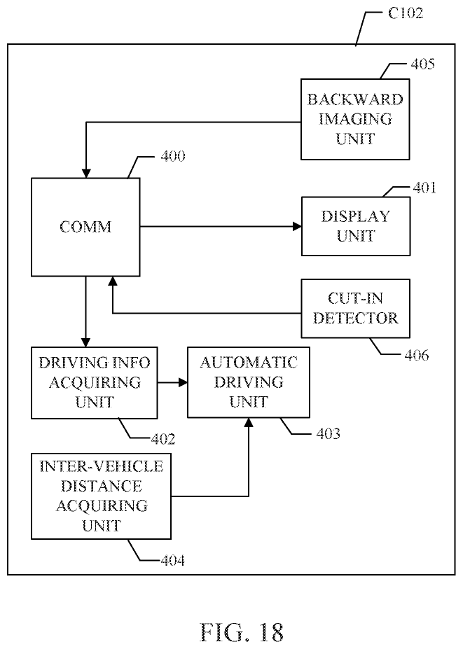

FIG. 18 is a configuration diagram of the line-end unmanned vehicle C102 in the preceding caravan 1000 in this embodiment. The unmanned vehicle C102 includes a communication unit 400, a display unit 401, a driving information acquiring unit 402, an automatic driving unit 403, an inter-vehicle distance acquiring unit 404, a backward imaging unit 405, and a cut-in detector (detector) 406.

The communication unit 400 exchanges information such as information about the number of vehicles in the caravan, overall length information about the caravan, driving information, position information, and in-vehicle (on-board) camera images by wireless communication between vehicles using radio waves, light, or the like. The display unit 401 notifies the driver of the vehicle driving behind the caravan of the number of vehicles in the caravan and overall length information about the caravan by means of a display unit such as an electronic display apparatus which can arbitrarily change numerical values. The driving information acquiring unit 402 acquires driving information such as the speed, acceleration, brake pressure, target acceleration/deceleration, and steering amount of the leading vehicle C100 in the preceding caravan 1000 via the communication unit 400, and notifies the automatic driving unit 403 of the driving information. The inter-vehicle distance acquiring unit 404 analyzes information from a forward surveillance camera, LiDAR, millimeter wave radar, and the like installed on the unmanned vehicle C102 and acquires a distance from the unmanned vehicle C101 in the preceding caravan 1000. The automatic driving unit 403 performs electronic connection with the unmanned vehicle C101 in the preceding caravan 1000 based on the information from the driving information acquiring unit 402 and the inter-vehicle distance acquiring unit 404. The backward imaging unit 405 is an image pickup apparatus such as a camera that captures an image behind the unmanned vehicle C102 (backward image).

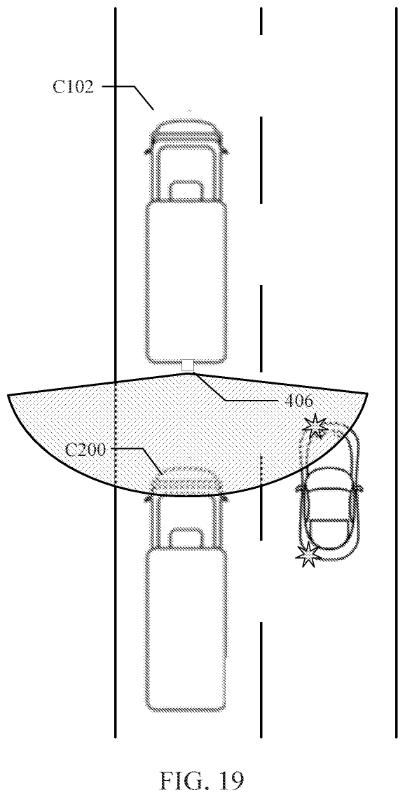

The cut-in detector 406 detects that another vehicle tries to cut in between the preceding caravan 1000 and the following caravan 2000. For example, the cut-in detector 406 captures an image of a vehicle driving in an adjacent lane diagonally behind the unmanned vehicle C102, and detects by machine learning or the like that the vehicle is emitting a blinker toward the lane in which the unmanned vehicle C102 is driving. FIG. 19 explains how the cut-in detector 406 detects a vehicle trying to cut in, which is driving in an adjacent lane and located diagonally behind the unmanned vehicle C102. A method of detecting a vehicle trying to cut in can use an image captured by the backward imaging unit 405, an image captured by an electronic mirror that captures an image diagonally behind the unmanned vehicle C102, or an image captured by a camera dedicated to detection of a vehicle trying to cut in.

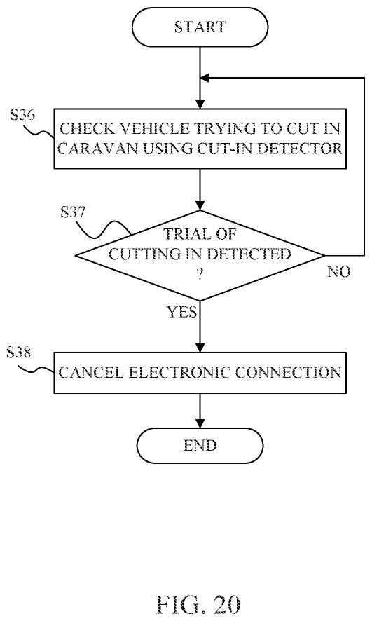

FIG. 20 illustrates a flowchart of control according to this embodiment for canceling electronic connection and for allowing another vehicle to cut in the caravan, in a case where the other vehicle trying to cut in the electronically connected caravan is detected.

First, in step S36, after the preceding caravan 1000 and the following caravan 2000 are electronically connected, the cut-in detector 406 of the unmanned vehicle C102 checks whether there is a vehicle trying to cut in the caravan. Next, in step S37, the cut-in detector 406 determines whether or not there is a vehicle trying to cut in the caravan. In a case where the cut-in detector 406 determines that there is no vehicle trying to cut in the caravan, the flow returns to step S36 to continue check whether there is a vehicle trying to cut in the caravan. On the other hand, in a case where the cut-in detector 406 determines that there is a vehicle trying to cut in, the flow proceeds to step S38. In step S38, the cut-in detector 406 cancels the electronic connection between the preceding caravan 1000 and the following caravan 2000, and allows the vehicle to cut in the caravan. The control for canceling the electronic connection between the preceding caravan 1000 and the following caravan 2000 conforms to the control of the fourth embodiment.

In a case where a vehicle trying to cut in the electronically connected caravan is detected, the control according to this embodiment cancels the electronic connection and allows the vehicle to cut in the caravan. Thereby, a vehicle trying to cut in the caravan can be allowed to safely cut in.

The present disclosure can provide a control apparatus that can reduce the burden on the driver.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2022-128608, filed on Aug. 12, 2022, which is hereby incorporated by reference herein in its entirety.

What is claimed is:

1. A control apparatus comprising:
a memory storing instructions; and
a processor configured to execute the instructions to:
acquire forward information ahead of a first vehicle in a first caravan,
acquire road information based on location data and map data,
determine, based on the forward information and the road information, whether or not electronic connection between the first caravan and a second caravan following the first caravan is possible, and
transmit to a second vehicle in the second caravan first information indicating that the electronic connection is possible in a case where it is determined that the electronic connection is possible.

2. The control apparatus according to claim 1, wherein the processor is configured to:
acquire speed information about the first vehicle, and
determine, based on the speed information, whether the electronic connection is possible.

3. The control apparatus according to claim 1, wherein the processor is configured to transmit driving information to the second vehicle according to a request for the driving information about the first vehicle from the second vehicle.

4. The control apparatus according to claim 1, wherein the memory is configured to store information about the number of vehicles in the first caravan, an overall length of the first caravan, and a distance between vehicles in the first caravan, and
wherein the processor is configured to transmit to the second vehicle the information about the number of vehicles in the first caravan, the overall length of the first caravan, and the distance between vehicles in the first caravan.

5. The control apparatus according to claim 1, wherein the processor is configured to cause a display unit to display an image of an imaging unit configured to capture an image behind the second caravan.

6. The control apparatus according to claim 1, the processor is configured to transmit to the second vehicle information indicating that the electronic connection will be canceled in a case where it is determined that the electronic connection cannot be continued while the electronic connection is executed.

7. The control apparatus according to claim 6, wherein the processor is configured to:
detect a vehicle trying to cut in between the first and second caravans, and
cancel the electronic connection in a case where the vehicle trying to cut in is detected.

8. The control apparatus according to claim 1, wherein the first vehicle is a leading vehicle in the first caravan, and the second vehicle is a leading vehicle in the second caravan.

9. A control apparatus comprising:
a memory storing instructions; and
a processor configured to execute the instructions to:
receive from a first vehicle in a first caravan first information indicating that electronic connection between the first caravan and a second caravan following the first caravan is possible,
notify, in a case where the first information is received, a driver of a second vehicle in the second caravan that electronic connection is possible,
determine, based on operation of a notified driver, whether or not to automatically drive the second vehicle, and
perform automatic driving, in a case where it is determined that the automatic driving is to be performed, based on information on a distance from the first caravan.

10. The control apparatus according to claim 9, wherein the processor is configured to:
determine whether the first caravan and the second caravan are adjacent, and
notify the driver that the electronic connection is possible, in a case where the first information is received and it is determined that the first caravan and the second caravan are adjacent.

11. The control apparatus according to claim 9, wherein the processor is configured to request the first caravan for driving information and receive the driving information from the first caravan.

12. The control apparatus according to claim 9, wherein the memory is configured to store information on the number of vehicles in the second caravan, an overall length of the second caravan, and a distance between vehicles in the second caravan, and
wherein the processor is configured to:
calculate an overall length of electronically connected first and second caravans,
receive, from the first caravan, information on the number of vehicles in the first caravan, an overall length of the first caravan, and a distance between vehicles in the first caravan, and
calculate the overall length of the electronically connected first and second caravans based on the information stored in the memory and the information received from the first caravan.

13. The control apparatus according to claim 9, wherein the processor is configured to cause a display unit to display an image of an imaging unit configured to capture an image behind the second caravan.

14. The control apparatus according to claim 9, wherein the processor is configured to notify the driver, in a case where information indicating that the electronic connection is to be canceled is received from the first vehicle, of switching from the automatic driving to manual driving, and to switch the automatic driving to the manual driving.

15. The control apparatus according to claim 9, wherein the first vehicle is a leading vehicle in the first caravan, and the second vehicle is a leading vehicle in the second caravan.

16. A control system configured to control driving of a first caravan and a second caravan following the first caravan, the control system comprising:
a first control apparatus provided to the first caravan; and
a second control apparatus provided to the second caravan,
wherein the first control apparatus includes:
a memory storing instructions; and
a processor configured to execute the instructions to:
acquire forward information ahead of a first vehicle in the first caravan,
acquire road information based on location data and map data,
determine, based on the forward information and the road information, whether or not electronic connection between the first caravan and the second caravan is possible, and
transmit to the second vehicle first information indicating that the electronic connection is possible in a case where it is determined that the electronic connection is possible, and
wherein the second control apparatus includes:
a memory storing instructions; and
a processor configured to execute the instructions to:
receive the first information from the first vehicle,
notify, in a case where the first information is received, a driver of a second vehicle in the second caravan that the electronic connection is possible,
determine, based on operation of a notified driver, whether or not to automatically drive the second vehicle, and
perform automatic driving, in a case where it is determined that the automatic driving is to be performed, based on information on a distance from the first caravan.

17. A control method comprising the steps of:
acquiring forward information ahead of a first vehicle in a first caravan,
acquiring road information based on location data and map data,
determining, based on the forward information and the road information, whether or not electronic connection between the first caravan and a second caravan following the first caravan is possible, and
transmitting to a second vehicle in the second caravan first information indicating that the electronic connection is possible in a case where it is determined that the electronic connection is possible.

18. A non-transitory computer-readable medium storing a program characterized by causing a computer to execute the control method according to claim 17.

19. A control method comprising the steps of:
receiving from a first vehicle in a first caravan first information indicating that electronic connection between the first caravan and a second caravan following the first caravan is possible,
notifying, in a case where the first information is received, a driver of a second vehicle in the second caravan that electronic connection is possible, determining, based on operation of a notified driver, whether or not to automatically drive the second vehicle, and
performing automatic driving, in a case where it is determined that the automatic driving is to be performed, based on information on a distance from the first caravan.

20. A non-transitory computer-readable medium storing a program characterized by causing a computer to execute the control method according to claim 19.
